(19) United States
(12) Patent Application Publication
(10) Pub. No.: US 2026/0025626 A1
(43) Pub. Date: Jan. 22, 2026

(54) VOICE TRANSMISSION DEVICE

(71) Applicant: FILLTUNE, Inc., Tokyo (JP)

(72) Inventors: Junichi ISOBE, Tokyo (JP); Koji FUKUNAGA, Tokyo (JP)

(21) Appl. No.: 19/346,560

(22) Filed: Oct. 1, 2025

Related U.S. Application Data
(63) Continuation of application No. PCT/JP2024/010769, filed on Mar. 19, 2024.

(30) Foreign Application Priority Data
Apr. 13, 2023 (JP) 2023-065625

(51) Int. Cl. H04R 25/00; H04R 1/10; H04R 15/00

(52) U.S. Cl. CPC H04R 25/606; H04R 1/1008; H04R 15/00; H04R 25/48; H04R 25/65

(57) ABSTRACT

A voice transmission device 1 of the present disclosure includes: a transducer 2; a transmission plate 3 configured to transmit a mechanical vibration to a bone of a head of a person; a housing 4 that houses the transducer 2; and a ring member 7 arranged to cover a side surface of the housing 4. The transducer includes: a magnetostrictive element 21; permanent magnets 22a, 22b arranged at both ends of the magnetostrictive element 21; and a coil 23. The permanent magnet 22a arranged at one end of the magnetostrictive element 21 is connected to a transmission plate 3. The housing 4 includes: a housing portion 41 that houses the transducer 2; and a counter mass 42 connected to the permanent magnet 22b arranged at the other end. The ring member 7 holds a side surface of the housing 4 via a damper member 6.

### CROSS-REFERENCE TO RELATED APPLICATIONS

This Application claims the benefit of priority and is a Continuation application of the prior International Patent Application No. PCT/JP2024/010769, with an international filing date of March 19, 2024, which designated the United States, and is related to the Japanese Patent Application No. 2023-065625, filed April 13, 2023, the entire disclosures of all applications are expressly incorporated by reference in their entirety herein.

### TECHNICAL FIELD

The present invention relates to a bone conduction type voice transmission device using a magnetostrictive element.

### BACKGROUND OF THE INVENTION

Conventionally, an air conduction hearing aid that transmits sound from a speaker to an auditory system as air-conducted sound, and a bone conduction hearing aid that transmits sound by converting an electrical signal of the sound into a vibration of a vibrator to vibrate a skull of a person have been developed. In the air conduction hearing aid, the air-conducted sound transmitted from the speaker vibrates an eardrum of a person, and the vibration is transmitted through auditory organs such as a cochlea to an auditory nerve and recognized as sound. On the other hand, in the bone conduction hearing aid, the vibration transmitted from the vibrator and converted from the electrical signal of the sound is transmitted through the skull directly to the cochlea and recognized as sound. The above described bone conduction transducer that converts the electrical signal of the sound into the vibration is utilized not only for hearing assistance applications but also for audio applications.

For example, Patent Document 1 discloses a bone conduction transducer including a magnet, a yoke, a coil and a diaphragm. In the technology described in Patent Document 1, the vibration is transmitted to the skull through the diaphragm coupled to the coil. This suppresses the occurrence of unwanted air-conducted sound due to the space between the magnet and the human body. As a result, good acoustic characteristics and quality can be achieved.

On the other hand, it is known that deafness cannot always be sufficiently compensated even using the conventional hearing aid developed as described above. For example, it is known that severe sensorineural hearing loss, which is primarily caused by inner ear disorders, cannot be sufficiently compensated by the conventional hearing aid. Therefore, Patent Document 2 discloses a completely implantable auxiliary device for sensorineural hearing loss that can cover sounds in the human audible frequency band across the entire range. The above described auxiliary device for sensorineural hearing loss is an artificial sensory epithelium to be implanted in a cochlea of a patient, wherein electrical stimulation is applied to spiral ganglion cells by microelectrodes of a piezoelectric membrane provided along the basilar membrane in the cochlea of the patient.

### PRIOR ART DOCUMENT

### PATENT DOCUMENTS

Patent Document 1: Japanese Patent No. 4580025 Patent Document 2: Japanese Patent No. 6029056

### SUMMARY OF THE INVENTION

### PROBLEM TO BE SOLVED BY THE INVENTION

In neural transmission in the human auditory system, the electrical signal generated by the action of hair cells in the cochlea is transmitted to the brain via spiral ganglion cells. Specifically, when the vibration of the eardrum of the person receiving air-conducted sound or the vibration delivered through the skull of the person reaches the cochlea, the outer hair cells that receive the vibration perform contractile movements. Then, inner hair cells convert the vibration of the outer hair cells accompanied by the contractile movements into the electrical signal.

Here, since the outer hair cells perform contractile movements upon receiving the vibrations, the outer hair cells tend to degenerate more easily compared to the inner hair cells and tend to fall off with aging. When the outer hair cells decrease, the adjustment such as amplification and suppression of the vibration delivered to the cochlea becomes difficult. For example, it becomes difficult to hear high sounds clearly or to hear consonants clearly. Thus, it becomes difficult to hear sounds clearly.

Since the conventionally known hearing aid assists the delivery of the vibration to the cochlea, if the outer hair cells in the cochlea have died, the hearing aid cannot supplement the function of the outer hair cells. For example, although the bone conduction transducer described in Patent Document 1 is a technology that can achieve good acoustic characteristics and quality, it is limited to the technology that delivers the vibration to the cochlea and cannot assist the function of the outer hair cells. As described above, age-related hearing loss associated with dysfunction of the outer hair cells cannot be sufficiently compensated by the conventional hearing aid.

On the other hand, according to the technology described in Patent Document 2, the electrical stimulation can be directly applied to the spiral ganglion cells by the artificial sensory epithelium. However, the above described artificial sensory epithelium is implanted in the cochlea of the patient. Namely, the artificial sensory epithelium involves invasion of the patient and imposes a heavy burden on the patient. Moreover, the effect of the artificial sensory epithelium can only be obtained by the patient who has undergone surgery. Thus, the artificial sensory epithelium has low versatility compared to the hearing aid that works through intervention with the patient. An interventional voice transmission device that can directly deliver the vibration representing voice information to the spiral ganglion cells without attenuation and with high frequency resolution has not yet been clarified.

The purpose of the present disclosure is to provide a voice transmission device that can deliver clear voice to a user without invading the user and can be practically used.

### MEANS FOR SOLVING THE PROBLEMS

A voice transmission device of the present disclosure includes: a transducer configured to convert a predetermined electrical signal into a mechanical vibration; a transmission plate configured to be fixed to contact a head of a person during use to transmit the mechanical vibration to a bone of the head of the person; a housing that houses the transducer; and a ring member arranged to cover a side surface of the housing. The transducer includes: a magnetostrictive element extending and contracting in a longitudinal direction according to a magnetic field; permanent magnets arranged at both ends of the magnetostrictive element in the longitudinal direction; and a coil arranged to surround a radial direction of the magnetostrictive element so that a current corresponding to the predetermined electrical signal flows through the coil. One of the permanent magnets arranged at one end of the magnetostrictive element is connected to the transmission plate. The housing includes: a housing portion that houses the transducer; and a counter mass having a predetermined mass, the counter mass being connected to the other of the permanent magnets arranged at the other end of the magnetostrictive element and connected to the housing portion. The ring member is configured to fix the voice transmission device by being supported by a predetermined wearable article to hold the side surface of the housing via a damper member.

The above described voice transmission device is a bone conduction type voice transmission device using a magnetostrictive element. When the current corresponding to the electrical signal flows through the coil of the transducer, the magnetic field is generated by the coil and the magnetostrictive element is extended and contracted in the longitudinal direction by the magnetic field. Note that the permanent magnets (e.g., neodymium magnets) are arranged at both ends of the magnetostrictive element in the longitudinal direction, and a steady magnetic field is applied to the magnetostrictive element by the permanent magnets. Here, in the above described permanent magnets, one of the permanent magnets arranged at one end of the magnetostrictive element is connected to the transmission plate. Therefore, the extension and contraction (mechanical vibration) of the magnetostrictive element is transmitted to the transmission plate, and the transmission plate vibrates upon receiving the mechanical vibration. Then, the above described mechanical vibration can be transmitted to bones of a head of a person by the transmission plate that is fixed to contact the head of the person during use. Namely, the mechanical vibration converted from the electrical signal by the transducer can be delivered to a person’s hearing by bone conduction via the transmission plate. The above described electrical signal is, for example, an electrical signal based on sound information. In this case, the voice transmission device may further include a microphone configured to be able to detect external sound and convert the detected sound into the electrical signal for output. According to the above described configuration, the voice transmission device of the present disclosure can be used as a hearing aid. In addition, the voice transmission device of the present disclosure may be connected to a predetermined audio device to convert the electrical signal output from the audio device and stimulate human hearing.

Here, the magnetostrictive element of the present disclosure is an element composed of a magnetostrictive material made of an alloy such as terbium or gallium. Thus, the stretching force is very large and the response speed is very fast. Therefore, in the voice transmission device using the magnetostrictive element as a vibrator, compared to the conventional bone conduction type hearing aid, it seems that the mechanical vibration converted from the electrical signal can be delivered deep into the cochlea of the person without attenuation. However, the discloser of the present invention has newly found that the mechanical vibration due to the extension and contraction of the magnetostrictive element cannot be delivered deep into the cochlea of the person merely by using the above described magnetostrictive element as a vibrator. Therefore, in the voice transmission device of the present disclosure, a counter mass constituting the housing that houses the transducer is connected to the other of the permanent magnets arranged at the other end of the magnetostrictive element in the above described permanent magnets. Namely, in the magnetostrictive element extending and contracting in the longitudinal direction, a predetermined mass is added to the other end opposite to one end connected to the transmission plate. Thus, the counter mass guides the displacement of the magnetostrictive element to the side connected to the transmission plate in the transducer. Because of this, it is possible to guide the very large stretching force and response speed of the magnetostrictive element toward the transmission plate. Thus, the mechanical vibration can be delivered to the human hearing via the transmission plate. Here, in the conventional bone conduction type hearing aid, the mechanical vibration tends to be attenuated by the skin and fat of the head of the person. However, in the voice transmission device of the present disclosure, the mechanical vibration can be delivered deep into the cochlea of the person without attenuation by the very large stretching force of the magnetostrictive element. Because of this, even if the outer hair cells in the cochlea have died, high-frequency vibrations can be directly delivered to the inner hair cells and the spiral ganglion cells by the very large stretching force and response speed of the magnetostrictive element. Namely, it becomes possible to deliver clear voice to the user. Unlike the hearing aid that requires invasive procedures such as cranial surgery for the user, the voice transmission device of the present disclosure works only through the intervention with users and can be shared without limiting users with high publicness.

In the above described voice transmission device, the ring member supported by a predetermined wearable article holds the side surface of the housing via the damper member. Because of this, sound leakage to the outside can be prevented while maintaining vibration transmission characteristics of the magnetostrictive element. Here, the ring member may include a protrusion protruding outward from each point at two points where a diameter and an outer circumference intersect, the protrusion may be rotatably supported by the wearable article, and the ring member may be supported by the wearable article so that a gap is formed between an outer circumferential surface of the ring member and the wearable article. Because of this, the transmission of the vibration to the outside can be suppressed as much as possible. In this case, a range of Shore hardness value of the damper member may be 30A to 50A.

In the above described voice transmission device, the counter mass may be formed in a roughly hemispherical shape and arranged so that the central axis of the counter mass substantially coincides with the central axis of the transducer. Because of this, the very large stress generated by the magnetostrictive element can be suitably received by the counter mass. Thus, the displacement of the magnetostrictive element can be suitably guided to the side connected to the transmission plate in the transducer. Furthermore, the above described shape and arrangement of the counter mass contribute to making the counter mass as compact and lightweight as possible. In addition, according to the above described configuration, the situation where the housing vibrates can be suppressed.

Furthermore, in the above described voice transmission device, one of the permanent magnets arranged at one end of the magnetostrictive element may be connected to the transmission plate via a push rod arranged between the permanent magnet and the transmission plate and the push rod may receive an urging force from a disc spring to press the permanent magnet arranged at one end of the magnetostrictive element and apply a preload to the magnetostrictive element. Because of this, the structure for applying the preload to the magnetostrictive element can be made as small as possible. Thus, miniaturization of the device is enabled. In this case, the push rod may have a predetermined acute angle portion at a tip on the transmission plate side and the acute angle portion may be thrust into the transmission plate. Because of this, the vibration transmission characteristics of the magnetostrictive element can be improved.

### EFFECTS OF THE INVENTION

According to the present disclosure, it is possible to provide a voice transmission device that can deliver clear voice to a user without invading the user and can be practically used.

### BRIEF DESCRIPTION OF DRAWINGS

FIG. 1 is a drawing showing a schematic configuration of a voice transmission device in an embodiment.

FIG. 2 is a first drawing showing a headphone-type hearing aid to which the voice transmission device of the embodiment is applied.

FIG. 3 is a drawing for explaining a guidance of a displacement of a magnetostrictive element by a counter mass.

FIG. 4 is a drawing for explaining an arrangement of a damper member inserted between a ring member and a housing.

FIG. 5 is a drawing for explaining an effect of the damper member.

FIGS. 6A to 6C are drawings for explaining a support manner of the voice transmission device with respect to a casing of the hearing aid.

FIG. 7 is a second drawing showing a headphone-type hearing aid to which the voice transmission device of the embodiment is applied.

### DETAILED DESCRIPTION OF THE INVENTION

Hereinafter, embodiments of the present disclosure will be explained based on the drawings. The configurations of the following embodiments are illustrative and the present disclosure is not limited to the configurations of the embodiments.

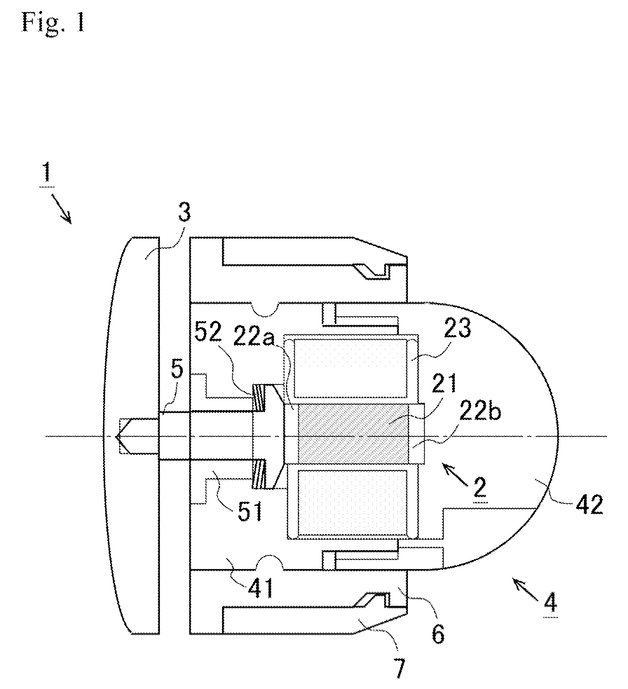

An overview of the voice transmission device in the present embodiment will be explained with reference to FIG. 1. FIG. 1 is a drawing showing a schematic configuration of the voice transmission device in the present embodiment. A voice transmission device 1 according to the present embodiment is a bone conduction type voice transmission device using a magnetostrictive element. The voice transmission device 1 includes: a transducer 2 configured to convert a predetermined electrical signal into a mechanical vibration; a transmission plate 3 configured to transmit the mechanical vibration; a housing 4 that houses the transducer 2; and a ring member 7 arranged to cover a side surface of the housing 4. Here, the above described electrical signal is an electrical signal based on sound information.

The transducer 2 includes: a magnetostrictive element 21; permanent magnets 22a, 22b arranged at both ends of the magnetostrictive element 21 in a longitudinal direction; and a coil 23 through which a current corresponding to an electrical signal flows. As shown in FIG. 1, the above described transducer 2 is housed in an insertion hole (an insertion hole on a central axis of a housing portion 41) formed in the housing 4. The housing 4 includes: a housing portion 41 that houses the transducer 2; and a counter mass 42 having a predetermined mass.

The magnetostrictive element 21 is an element formed in a cylindrical shape from a predetermined magnetostrictive material. As shown in FIG. 1, the magnetostrictive element 21 extends so that the longitudinal direction of the magnetostrictive element 21 is along a central axis of the housing 4. The permanent magnets 22a, 22b are arranged at both ends of the magnetostrictive element 21 in the longitudinal direction. The coil 23 is arranged to surround a radial direction of the magnetostrictive element 21. Here, the permanent magnets 22a, 22b are, for example, neodymium magnets. A steady magnetic field is applied to the magnetostrictive element 21 by the permanent magnets 22a, 22b.

When the current corresponding to the electrical signal flows through the coil 23, a magnetic field is generated by the coil 23 and thus the magnetostrictive element 21 is extended and contracted in the longitudinal direction. Here, in the present disclosure, the magnetostrictive element 21 is composed of a magnetostrictive material made of an alloy such as terbium or gallium. Because of this, very large stretching force and very fast response speed can be achieved compared to the conventional magnetostrictive element.

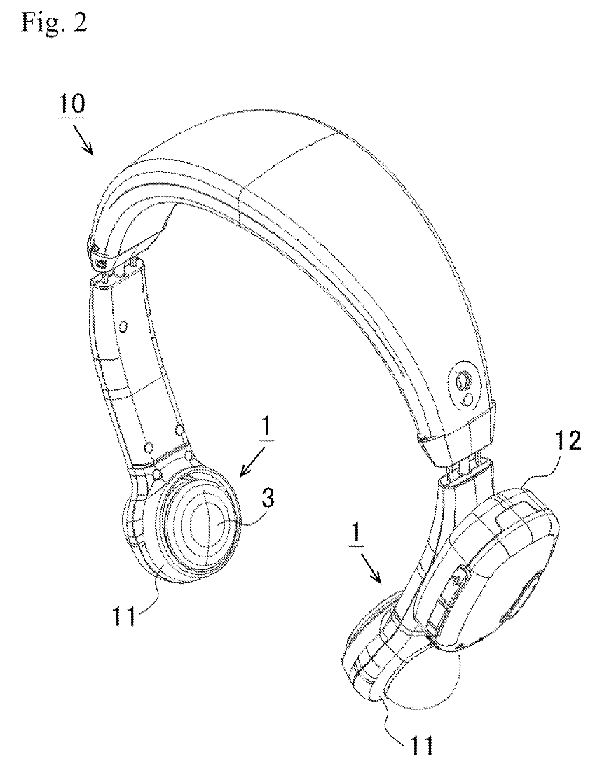

The transmission plate 3 is connected to the permanent magnet 22a arranged at one end of the magnetostrictive element 21. Therefore, the extension and contraction (mechanical vibration) of the magnetostrictive element 21 is transmitted to the transmission plate 3 and the transmission plate 3 vibrates upon receiving the mechanical vibration. Thus, the mechanical vibration converted from the electrical signal by the transducer 2 can be transmitted to bones of a head of a person via the transmission plate 3. The above described structure will be explained below based on FIG. 2.

FIG. 2 is a first drawing showing a headphone-type hearing aid to which the voice transmission device 1 of the present embodiment is applied. In the hearing aid 10 shown in FIG. 2, the voice transmission device 1 is housed in a casing 11. The casing 11 is integrated with a headband. The hearing aid 10 is formed as an over-head type by the headband. The hearing aid 10 is provided with: a microphone configured to be able to detect the external sound; and a battery 12 that functions as a power source for the microphone and transducer 2. In the above described hearing aid 10, the external sound is converted into the electrical signal and output by the microphone. The electrical signal output from the microphone is converted into the mechanical vibration by the transducer 2 of the voice transmission device 1 and transmitted to the transmission plate 3. Although FIG. 2 illustrates the configuration including the battery 12 as a power source for the microphone and transducer 2, there is no intention to limit to this configuration. It is also possible to connect a predetermined power source by wire.

Here, as shown in FIG. 2, the transmission plate 3 is configured to be fixed to contact a head of a person during use to transmit the mechanical vibration from the transducer 2 to bones of the head of the person. Specifically, when the magnetostrictive element 21 extends and contracts (mechanical vibration) based on the electrical signal output from the microphone, the mechanical vibration is transmitted from the permanent magnet 22a arranged at one end of the magnetostrictive element 21 to the transmission plate 3 via a push rod 5 and the transmission plate 3 transmits the mechanical vibration from the transducer 2 to bones of the head of the person. Namely, the mechanical vibration converted from the electrical signal by the transducer 2 can be delivered to the human hearing by bone conduction via the transmission plate 3.

Returning to FIG. 1, in the voice transmission device 1 according to the present embodiment, the push rod 5 receives urging force from a disc spring 52 to press the permanent magnet 22a arranged at one end of the magnetostrictive element 21. Thus, a preload is applied to the magnetostrictive element 21. Here, it is also possible to apply the preload to the magnetostrictive element 21, for example, using the urging force of a coil spring. However, the coil spring requires a large space for arrangement compared to the disc spring. Therefore, there is a concern that the voice transmission device may become large. In contrast, in the present embodiment, the push rod 5 has a flange-shaped seating surface like a flange bolt, and the disc spring 52 is arranged between the seating surface and a counterbore portion where the seating surface is seated in the housing portion 41 of the housing 4. Thus, the flange portion of the push rod 5 is urged by the disc spring 52. In addition, since the top surface of the flange portion of the push rod 5 is in contact with the permanent magnet 22a arranged at one end of the magnetostrictive element 21, the urging force from the disc spring 52 acts on the permanent magnet 22a. Namely, the push rod 5 receives the urging force from the disc spring 52 to press the permanent magnet 22a arranged at one end of the magnetostrictive element 21. According to the above described configuration, the structure for applying the preload to the magnetostrictive element 21 can be made as small as possible. Thus, miniaturization of the device is enabled. As a result of applying the preload to the magnetostrictive element 21 in the above described manner, the amount of extension and contraction of the magnetostrictive element 21 can be increased.

Furthermore, the push rod 5 may have a predetermined acute angle portion at the tip on the transmission plate 3 side and the acute angle portion may be thrust into the transmission plate 3. Here, the push rod 5 has a male thread formed on the transmission plate 3 side and the push rod 5 is integrated with the transmission plate 3 by screw fastening. At this time, it is important that the extension and contraction (mechanical vibration) of the magnetostrictive element 21 is transmitted to the transmission plate 3 without loss. Therefore, in the present embodiment, the acute angle portion at the tip of the push rod 5 is thrust into the transmission plate 3 and thus the contact area of the push rod 5 with respect to the transmission plate 3 is increased. Because of this, the vibration transmission characteristics of the magnetostrictive element 21 can be improved. Note that the acute angle portion at the tip of the push rod 5 can be thrust into the transmission plate 3 to a depth of, for example, 0.3 mm.

In addition, in the housing portion 41 of the housing 4, a bush 51 is press-fitted into a portion where the push rod 5 slides. The bush 51 is, for example, a non-lubricated bush formed of a predetermined resin material. Because of this, smooth sliding of the push rod 5 can be achieved.

Here, in the conventional bone conduction hearing aid, the mechanical vibration tends to be attenuated by the skin and fat of the head of the person. Thus, the user using the conventional hearing aid may not be able to clearly hear sounds due to difficulty hearing high sounds or difficulty hearing consonants. On the other hand, in the voice transmission device 1 of the present disclosure using the magnetostrictive element 21 described above as a vibrator, it seems that the mechanical vibration can be delivered deep into the cochlea of the person without attenuation. However, the discloser of the present invention has newly found that it is impossible to deliver the mechanical vibration due to the extension and contraction of the magnetostrictive element 21 deep into the cochlea of the person by merely using the magnetostrictive element 21 described above as a vibrator. Therefore, in the voice transmission device 1 of the present disclosure, the counter mass 42 constituting the housing 4 that houses the transducer 2 is connected to the permanent magnet 22b arranged at the other end of the magnetostrictive element 21. Namely, in the magnetostrictive element 21 extending and contracting in the longitudinal direction, a predetermined mass is added to the other end opposite to one end connected to the transmission plate 3.

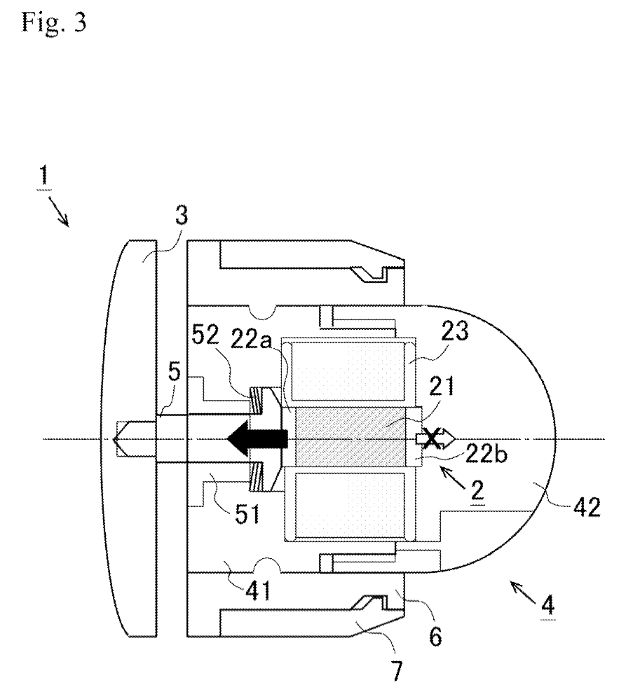

When the other end of the magnetostrictive element 21 is connected to the counter mass 42 as described above and a predetermined mass is added to the other end, the displacement of the magnetostrictive element 21 is guided to the side connected to the transmission plate 3 in the transducer 2 by the mass of the counter mass 42. Namely, as shown in FIG. 3, the displacement due to the extension and contraction of the magnetostrictive element in the transducer 2 is concentrated at the end on the side connected to the transmission plate 3. Note that FIG. 3 is a drawing for explaining the guidance of the displacement of the magnetostrictive element by the counter mass 42.

According to the above described configuration, it becomes possible to guide very large stress and response speed of the magnetostrictive element toward the transmission plate 3, and the above described mechanical vibration of the magnetostrictive element 21 can be delivered to human hearing via the transmission plate 3. Namely, in the voice transmission device 1 of the present disclosure, the mechanical vibration can be delivered deep into the cochlea of the person without attenuation by very large stretching force of the magnetostrictive element 21. Because of this, even if the outer hair cells in the cochlea have died, high-frequency vibrations can be directly delivered to the inner hair cells and the spiral ganglion cells by very large stretching force and response speed of the magnetostrictive element 21. Thus, the user using the voice transmission device 1 of the present disclosure can clearly hear high sounds and consonants. Namely, clear voice can be delivered to the user.

Unlike the hearing aid that requires invasive procedures such as cranial surgery for the user, the voice transmission device 1 of the present disclosure works only through the intervention with users and can be shared without limiting users with high publicness.

In the voice transmission device 1 of the present embodiment, when the maximum value of the mass of an object that the magnetostrictive element 21 in transducer 2 can move is defined as the maximum mass, the counter mass 42 may be configured such that the mass of the counter mass 42 is equal to or greater than a predetermined ratio of the maximum mass. Thus, the displacement due to the extension and contraction of the magnetostrictive element 21 can be suitably guided to the side connected to the transmission plate 3 in the transducer 2.

Furthermore, as shown in FIGS. 1 to 3, in the voice transmission device 1 of the present embodiment, the counter mass 42 may be formed in a roughly hemispherical shape and arranged so that the central axis of the counter mass substantially coincides with the central axis of the transducer 2.

As described above, the displacement of the magnetostrictive element is guided to the side connected to the transmission plate 3 in the transducer 2 by the mass of the counter mass 42. The discloser of the present invention has further found that the above described displacement can be more suitably guided to the transmission plate 3 side by forming the counter mass 42 in a roughly hemispherical shape. Specifically, the mass of the counter mass 42 having a roughly hemispherical shape is concentrated in the longitudinal direction of the magnetostrictive element by arranging the counter mass 42 such that the central axis of the counter mass 42 substantially coincides with the central axis of the transducer 2. Because of this, the force for receiving the stress based on the mass of the counter mass 42 can be concentrated in the direction where the stress of the magnetostrictive element works. Thus, very large stress of the magnetostrictive element can be suitably received by the counter mass 42. Consequently, the displacement of the magnetostrictive element can be more suitably guided to the side connected to the transmission plate 3 in the transducer 2. Furthermore, while the object with large mass tends to be required to receive very large stress of the magnetostrictive element, the above described shape and arrangement of the counter mass 42 contribute to making the counter mass 42 as compact and lightweight as possible.

Here, if the housing 4 vibrates due to the mechanical vibration of the magnetostrictive element 21, many noises would be included in the vibration waveforms of the mechanical vibration generated by the transducer 2 and clear sound cannot be delivered to the user. In addition, as a technology for removing noise, it is conventionally known to perform noise removal processing using DSP (Digital Sound Processor). However, in the above described processing, waveforms representing original input sound information are processed. Therefore, it may become difficult to accurately deliver the external sound detected by the microphone to the user.

On the other hand, since the counter mass 42 is formed in a roughly hemispherical shape, very large stress of the magnetostrictive element 21 can be suitably received by the counter mass 42 and the situation where the housing 4 vibrates can also be suitably suppressed. Thus, the situation where the noise is included in the vibration waveforms transmitted from the transducer 2 to the transmission plate 3 via the push rod 5 can be fundamentally suppressed. Consequently, the external sound detected by the microphone can be accurately delivered to the user.

Furthermore, in the voice transmission device 1 of the present embodiment, the ring member 7 arranged to cover the side surface of the housing 4 is supported by the hearing aid 10 (wearable article of the present disclosure) shown in FIG. 2. Thus, the voice transmission device 1 is fixed.

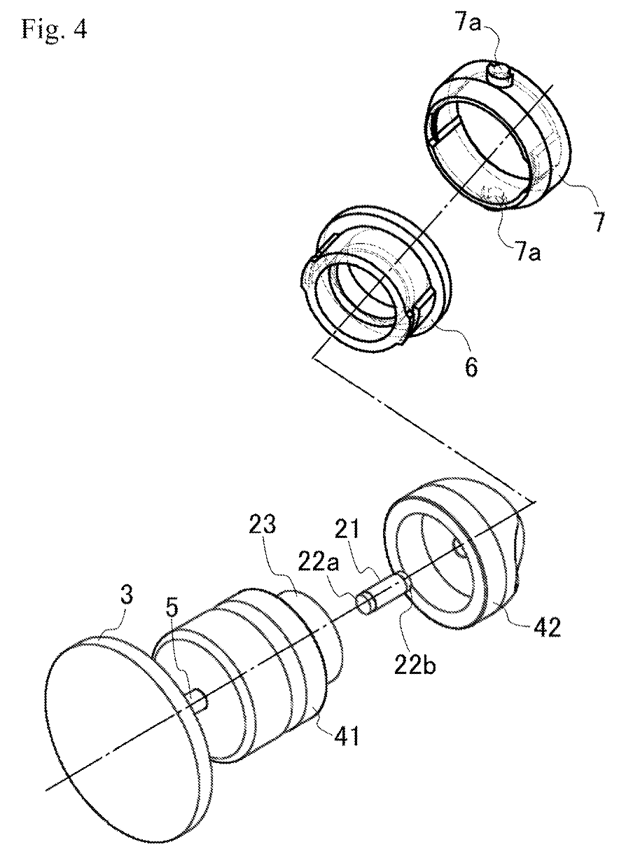

As shown in FIG. 1, the ring member 7 holds the side surface of the housing 4 via a damper member 6. Here, FIG. 4 is a drawing for explaining the arrangement of the damper member 6 inserted between the ring member 7 and the housing 4.

As shown in FIG. 4, the damper member 6 is also formed in a ring shape like the ring member 7 and is arranged to be fitted to an inner circumferential surface of the ring member 7. Since the damper member 6 is formed, for example, from thermoplastic elastomer, the vibration can be attenuated so that the vibration of the transducer 2 due to the extension and contraction of the magnetostrictive element 21 is not transmitted to the outside (e.g., the casing 11 of the hearing aid 10 shown in FIG. 2). Because of this, the sound leakage to the outside can be suppressed while maintaining the vibration transmission characteristics of the magnetostrictive element 21.

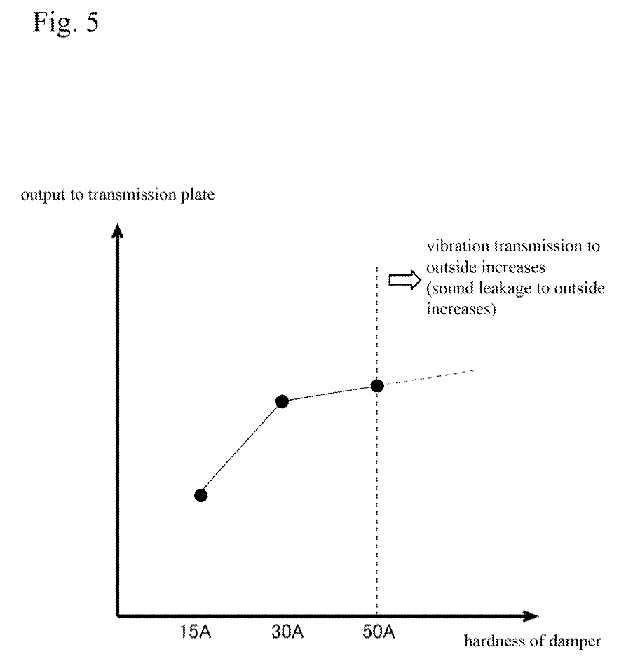

Specifically, the above described configuration can be achieved by setting a Shore hardness value of the damper member 6 in a range from 30A to 50A. This will be explained based on FIG. 5.

FIG. 5 is a drawing for explaining an effect of the damper member 6. FIG. 5 illustrates a comparison of the output characteristics of the vibration of the transducer 2 with respect to the transmission plate 3 by Shore hardness of the damper member 6. In FIG. 5, the comparison is shown for the cases where Shore hardness values of the damper member 6 are 15A, 30A, and 50A.

As shown in FIG. 5, comparing the cases where the Shore hardness value of the damper member 6 is 15A and 30A, when the Shore hardness value of the damper member 6 is 15A, the output of the vibration of the transducer 2 with respect to the transmission plate 3 is significantly reduced compared to the case of 30A. This is because the damping characteristics of the damper member 6 are too strong and vibrations that should be transmitted to the transmission plate 3 are greatly attenuated by the damper member 6. Namely, when the Shore hardness value of the damper member 6 is 15A, the vibration of the transducer 2 becomes difficult to transmit to the outside (e.g., the casing 11 of the hearing aid 10 shown in FIG. 2). Thus, the sound leakage to the outside can be effectively suppressed, but it may become difficult to maintain the vibration transmission characteristics of the magnetostrictive element 21 with respect to the transmission plate 3.

On the other hand, comparing the cases where the Shore hardness value of the damper member 6 is 30A and 50A, when the Shore hardness value of the damper member 6 is 50A, the output of the vibration of the transducer 2 with respect to the transmission plate 3 is increased compared to the case of 30A, but the difference is slight. Namely, in the voice transmission device 1 according to the present embodiment, regarding the output characteristics of vibration of the transducer 2 with respect to the transmission plate 3, the case where the Shore hardness value of the damper member 6 is 30A is an inflection point. From the above described result, it can be understood that if the Shore hardness value of the damper member 6 is 30A or more, the vibration transmission characteristics of the magnetostrictive element 21 with respect to the transmission plate 3 can be maintained.

In addition, the discloser of the present invention has newly found that when the Shore hardness value of the damper member 6 exceeds 50A, the damper member 6 becomes too hard and thus the vibration of the transducer 2 is easily transmitted to the outside (e.g., the casing 11 of the hearing aid 10 shown in FIG. 2). Because of this, when the Shore hardness value of the damper member 6 exceeds 50A, the vibration transmission to the outside increases and it becomes difficult to suppress the sound leakage to the outside. From the above described result, it can be understood that the sound leakage to the outside is suppressed while maintaining vibration transmission characteristics of the magnetostrictive element 21 by setting the Shore hardness value of the damper member 6 in a range from 30A to 50A.

In addition, in the voice transmission device 1 of the present embodiment, the ring member 7 may have protrusions 7a protruding outward from each point at two points where a diameter and an outer circumference intersect, the protrusions 7a may be pivotally supported by the hearing aid 10 (wearable article of the present disclosure) shown in FIG. 2, and the ring member 7 may be supported by the hearing aid 10 so that a gap is generated between an outer circumferential surface of the ring member 7 and the hearing aid 10.

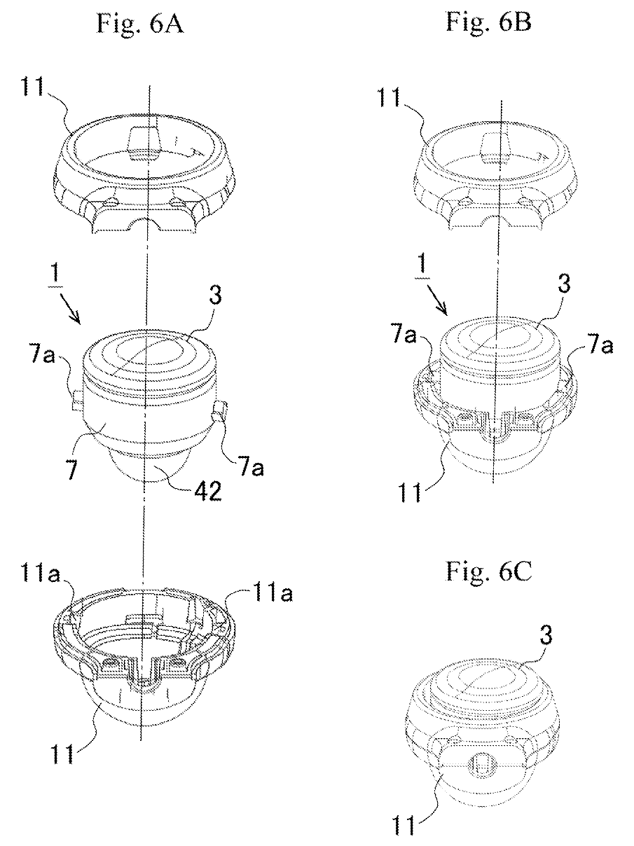

Here, FIGS. 6A to 6C are drawings for explaining a support manner of the voice transmission device 1 with respect to the casing 11 of the hearing aid 10. As shown in FIG. 6A, the voice transmission device 1 is arranged to be sandwiched by the casing 11 divided into two parts. At this time, as shown in FIGS. 6A and 6B, two protrusions 7a of the ring member 7 are pivotally supported in the support grooves 11a formed in the casing 11. In addition, the voice transmission device 1 is supported by the hearing aid 10 so that a gap is generated between an outer circumferential surface of the ring member 7 and the casing 11 of the hearing aid 10 when the projecting portions 7a are pivotally supported in the support grooves 11a. Thus, the voice transmission device 1 and the casing 11 do not contact each other except at the above pivotal support portions, and the transmission of the vibration of the transducer 2 to the outside (the casing 11 of the hearing aid 10) can be suppressed as much as possible. According to the above described support structure, as shown in FIG. 6C, even when the voice transmission device 1 is sandwiched in the casing 11 of the hearing aid 10, the voice transmission device 1 is configured to be rotatable with the above described pivotal support portion as a central axis. Therefore, a contact angle of the transmission plate 3 of the voice transmission device 1 with respect to the head of the person is automatically adjusted to the angle along the shape of the head.

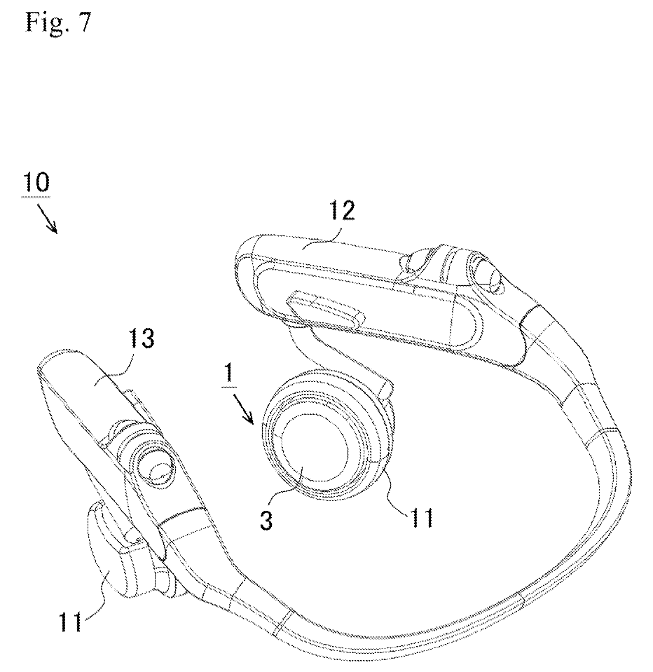

The voice transmission device 1 of the present embodiment may be applied to a back-band type hearing aid. FIG. 7 is a second drawing showing a headphone-type hearing aid to which the voice transmission device 1 of the present embodiment is applied. In the hearing aid 10 shown in FIG. 7, the voice transmission device 1 is housed in a casing 11 similar to the hearing aid 10 shown in FIG. 2. The casing 11 is integrated with a headband and the hearing aid 10 is formed as a back-band type by the headband. The hearing aid 10 is provided with: a microphone configured to be able to detect the external sound; and a battery 12 that functions as a power source for the microphone and transducer 2. In addition, in the hearing aid 10 shown in FIG. 7, an operation board 13 may be arranged.

According to the voice transmission device 1 described above, clear voice can be delivered to the user without invading the user and the voice transmission device 1 can be used practically.

### <Other variations>

The above embodiment is merely an example, and the present disclosure can be implemented with appropriate modifications within a scope not departing from a gist of the present disclosure. For example, processes and means described in the present disclosure can be freely combined and implemented as long as technical contradictions do not arise.

In the above described embodiment, an example of using the voice transmission device 1 for a hearing aid is described. However, there is no intention to limit usage forms of the voice transmission device of the present disclosure to the above described configuration. The voice transmission device of the present disclosure may be utilized for audio applications, for example. In this case, the voice transmission device of the present disclosure may be connected to a predetermined audio device and electrical signals output from the audio device may be converted into the mechanical vibration by the transducer to stimulate human hearing.

### DESCRIPTION OF THE REFERENCE NUMERALS

1: voice transmission device

2: transducer

21: magnetostrictive element

22a, 22b: permanent magnet

23: coil

3: transmission plate

4: housing

41: housing portion

42: counter mass

5: push rod

51: bush

52: disc spring

6: damper member

7: ring member

1. A voice transmission device comprising:
a transducer configured to convert a predetermined electrical signal into a mechanical vibration;
a transmission plate configured to be fixed to contact a head of a person during use to transmit the mechanical vibration to a bone of the head of the person;
a housing that houses the transducer; and
a ring member arranged to cover a side surface of the housing, wherein
the transducer includes:
a magnetostrictive element extending and contracting in a longitudinal direction according to a magnetic field;
permanent magnets arranged at both ends of the magnetostrictive element in the longitudinal direction; and
a coil arranged to surround a radial direction of the magnetostrictive element so that a current corresponding to the predetermined electrical signal flows through the coil,
one of the permanent magnets arranged at one end of the magnetostrictive element is connected to the transmission plate,
the housing includes:
a housing portion that houses the transducer; and
a counter mass having a predetermined mass, the counter mass being connected to the other of the permanent magnets arranged at the other end of the magnetostrictive element and connected to the housing portion,
the ring member is configured to fix the voice transmission device by being supported by a predetermined wearable article to hold the side surface of the housing via a damper member formed of a thermoplastic elastomer,
the ring member includes a protrusion protruding outward from each point at two points where a diameter and an outer circumference intersect,
the protrusion is rotatably supported by the wearable article with an axis of the protrusion as a central axis, and
the ring member is supported by the wearable article so that a gap is formed between an outer circumferential surface of the ring member and the wearable article.

2. The voice transmission device according to claim 1, wherein
a range of a Shore hardness value of the damper member is 30A to 50A.
